(19) United States
(12) Patent Application Publication
(10) Pub. No.: US 2006/0183615 A1
(43) Pub. Date: Aug. 17, 2006

(54) Tubular roller, method of manufacturing the same, and electro-photographic image forming apparatus having the same

(76) Inventors: Jong-moon Eun, Suwon-si (KR); Hee-won Jung, Suwon-si (KR); Tae-hyun Kim, Suwon-si (KR); In Kim, Suwon-si (KR)

Correspondence Address: STANZIONE & KIM, LLP, 919 18TH STREET, N.W., SUITE 440, WASHINGTON, DC, 20006, US

(21) Appl. No.: 11/354,993

(22) Filed: Feb. 16, 2006

(30) Foreign Application Priority Data
Feb. 16, 2005 (KR) 2005-12901

(51) Int. Cl. F16C 13/00

(52) U.S. Cl. 492/56; 29/895.21

(57) ABSTRACT

An elastic tubular roller includes an inner foam layer and an outer tubular layer, the inner foam layer has a higher electrical resistance than the outer tubular layer, and the electrical resistance of the entire tubular roller is equal to or less than 108Ω. A method of manufacturing the same and an electro-photographic image forming apparatus using the same. The tubular roller is used as various kinds of electro-photographic image forming apparatuses, such as a contact non-magnetic one-component type and a magnetic two-component type, and as well as an electrical charging roller and a developing roller.

### CROSS-REFERENCE TO RELATED APPLICATIONS

This application claims the benefit of Korean Patent Application No. 10-2005-0012901, filed on Feb. 16, 2005, in the Korean Intellectual Property Office, the disclosure of which is incorporated herein in its entirety by reference.

### BACKGROUND OF THE INVENTION

1. Field of the Invention

The present general inventive concept relates to a tubular roller, a method of manufacturing the same, and an electro-photographic imaging apparatus having the same, and more particularly, to a tubular roller to prevent problems of a conventional developing roller and to ensure low hardness and a simple and inexpensive fabricating process, a method of manufacturing the same, and an electro-photographic imaging apparatus having the same.

2. Description of the Related Art

A conventional electro-photographic imaging apparatus includes a photosensitive unit, a developing roller, a toner supply roller, a toner layer controller, an electric charging apparatus, a cleaning blade, a laser scanning unit, and other elements. The developing roller is positioned between the toner supply roller and the photosensitive unit. Toner is transferred from the toner supply roller to the developing roller, uniformly supplied by the toner layer controller installed on the developing roller, and then electrically charged by friction.

A contact type developing roller is used as the developing roller to contact various components, such as the toner supply roller, the toner layer controller, and the photosensitive unit. This reduces lifetime of the developing roller and a contact area between the developing roller and other component, increases toner stress, and leads to bad images.

Typically, the developing roller installed in a developing unit is supplied with a single-component or two-component developer by mechanical and/or electrostatic forces from the toner supply roller. The developing roller is made of aluminum or elastomer.

The elastomer may be a material selected from the group consisting of silicon rubber, acrylonitrile-butadiene rubber (NBR), polyurethane (PU), ethylene-propylene-diene polymer (EPDM), chloroprene rubber (CR), poly-vinylidene-fluoride (PVDF), and polyester. If the developing roller is an ionic conductive type, a salt-type additive may be added. In this case, an epichlorohidrin (ECO) rubber may be added to the elastomer. If the developing roller is an electronic conductive type, carbon black may be added instead of the ECO rubber.

In addition, hardness and resistance of the developing roller may vary depending on its function. Typically, in addition to ECO or carbon black, a filler, such as calcium carbonate, may be added to a manufacturing process. Otherwise, a coating made of a material selected from the group consisting of urethane resin, nylon, a fluorinate material, or polymer may be added to adjust the resistance of the developing roller.

A stepped conductive developing roller which is commercially available nowadays has a hardness of about 50 degrees (Asker type-A). For example, U.S. Pat. No. 5,126,913 discloses a tubular conductive roller in which a volume resistance of an outer layer is larger than that of an inner layer corresponding to a conductive elastic layer, thereby preventing generation of a non-conductive area due to electrical charge leakage. While the inner layer corresponding to the conductive elastic layer has a volume resistance of 103Ω or less, the outer layer has a volume resistance of about 107Ω. Thus, the volume resistance of the inner layer is negligible compared to that of the outer layer. In addition, Japanese Patent Laid-open No. 2002-358251 discloses a developing roller having a two-layer structure, in which an inner layer also has a smaller volume resistance than an outer layer.

Meanwhile, U.S. Pat. No. 5,543,899 discloses an electrical charging roller using a foam material, in which carbon, tin oxide, and the like are dispersed in polystyrene, polyamide, polyolefin, polyester, or polyurethane. The specific gravity of the foam material is within a range of 0.1 to 0.6 g/cm3, and a cell size of the foam material is 50 micron to 1 mm.

As described above, developing rollers can be classified into an ionic conductive type and an electronic conductive type according to whether an ionic additive, such ammonium salt, perchlorate, and chlorate, or an electronic conductive additive, such as carbon black, ketjen black, acetylene black, zinc oxide, titanium oxide, and silver, is used. The additive is correlated with a resistance of the developing roller. In other words, while the resistance of the ionic conductive developing roller is in the range of from 1×105 to 6×108Ω, the resistance of the electronic conductive developing roller is 5×106Ω or less.

Developing rollers are also classified into a single layer type roller and a double layer type roller. While the single layer type roller can be manufactured by a simple process at low cost, there is a limitation in reducing its hardness. In addition, the single layer type roller may have additional problems such as migration of low molecular weight additives and streaks due to viscosity. On the other hand, the double layer type roller includes a solid inner layer and a coated outer layer to provide superior printing quality, but is expensive due to additional processes such as coating. In addition, there is a limitation in reducing the hardness of the solid inner layer, wherein the low hardness is indispensable to minimize toner stress.

### SUMMARY OF THE INVENTION

The present general inventive concept provides a tubular roller to reduce migration of low molecular weight additives, streaks due to viscosity, and toner stress, has a low hardness of 45 degrees or less, and can be manufactured at low costs. The tubular roller reduces printing errors caused by an irregular electric field due to air gaps in a bonding surface between inner and outer layers thereof, and also has a regular tubular surface.

Additional aspects and advantages of the present general inventive concept will be set forth in part in the description which follows and, in part, will be obvious from the description, or may be learned by practice of the general inventive concept.

The foregoing and/or other aspects of the present general inventive concept may be achieved by providing an elastic tubular roller to provide electrical conductivity to an imaging apparatus, the roller comprising an inner foam layer and an outer tubular layer, wherein the inner foam layer has a higher electrical resistance than the outer tubular layer, and the electrical resistance of the entire tubular roller is equal to or less than 10⁸Ω.

The foregoing and/or other aspects of the present general inventive concept may also be achieved by providing a method of manufacturing a tubular roller, the method comprising providing an outer tubular layer by an extrusion or centrifugal forming process, mixing an elastomer, a crosslinking agent, a crosslinking accelerator, a blowing agent, and a conductive additive to obtain a mixture, obtaining an extruded material having a roller shape through an extrusion process similar to the extrusion of the outer tubular layer, using the mixture and injecting the extruded material into the outer tubular layer, and heating the injected material to foam, to provide an inner foam layer.

The foregoing and/or other aspects of the present general inventive concept may be achieved by providing an electro-photographic imaging apparatus having a tubular roller comprising an inner foam layer and an outer tubular layer, wherein the inner foam layer has a higher electrical resistance than the outer tubular layer, and the electrical resistance of the entire tubular roller is equal to or less than 10⁸Ω.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a perspective view of a tubular roller according to an embodiment of the present general inventive concept;

FIG. 2 is a cross-sectional view of the tubular roller in FIG. 1;

FIG. 3 is a perspective view of a roller processing machine that is used to manufacture a tubular roller according to the present general inventive concept;

FIG. 4 is a cross-sectional view of a contact type one-component non-magnetic electro-photographic image forming apparatus including the tubular roller of FIG. 1; and

FIG. 5 is a schematic diagram of an apparatus to measure electrical resistance of the tubular roller of FIG. 1.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

A developing roller according to an embodiment of the present general inventive concept has an inner foam layer and an outer tubular layer. An electrical resistance of the inner foam layer is greater than that of the outer tubular layer. The electrical resistance of the entire tubular roller is smaller than 108Ω.

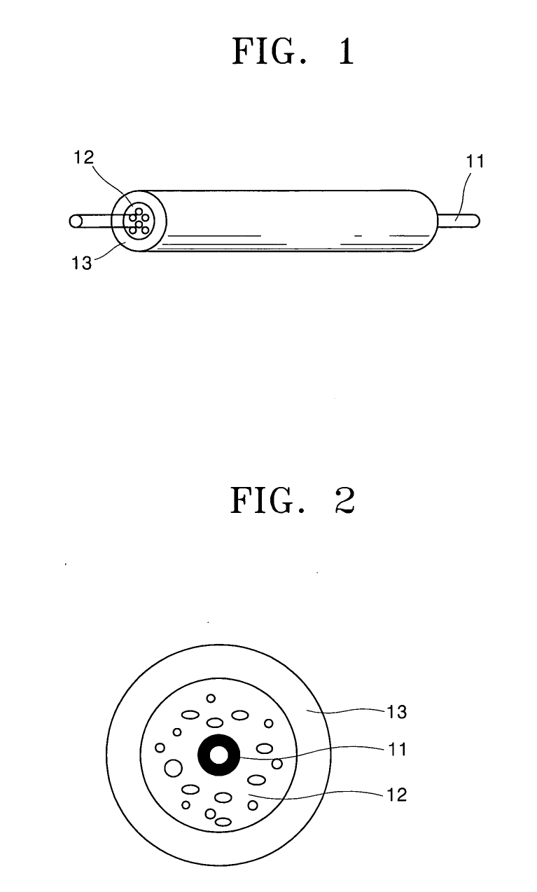

FIGS. 1 and 2 are a perspective view and a cross-sectional view of a tubular roller according to an embodiment of the present general inventive concept. As shown in FIGS. 1 and 2, the tubular roller includes an inner foam layer 12, an outer tubular layer 13, and a core or shaft 11.

The tubular roller can be used as a developing roller or an electrical charging roller in an electro-photographic imaging apparatus, such as a printer, a facsimile, or a duplicator, and has a low hardness double-layered structure. The tubular roller is useful in a developing method using non-magnetic toner, and more particularly, in a contact type friction control system using, for example, single component contact development.

The tubular roller includes an inner foam layer 12 and an outer tubular layer 13. The inner foam layer 12 is formed of a conductive foam, and the outer layer 13 is solid and may be a tube or a film. The electrical resistance of the inner foam layer 12 is equal to or less than that of the outer tubular layer 13.

This is because irregular resistances can occur in a radial direction due to a structural shape of the conductive foam of the inner form layer 12 when the tubular roller rotates, thus cause printing errors. In order to prevent the irregular resistance in the radial direction when the tubular roller rotates, the conductivity of the outer tubular layer 13 should be improved so that the outer tubular layer 13 has an equivalent voltage regardless of the inner form layer 12.

The electrical resistance of the entire tubular roller may be 108Ω or less. If the electrical resistance of the entire tubular roller is greater than 108Ω, electric field losses can occur and thus image density can decrease.

In the tubular roller according to the present embodiment, the inner foam layer 12 is made of foamed elastomer. The inner form layer 12 can be polyurethane (PU), silicon rubber (SR), ethylene-propylene-diene terpolymer (EPDM), a nitrile-butadiene rubber (NBR), polyolefin, nylon, polyimide, and compounds or copolymers of polymer/rubber, rubber/rubber, or polymer/polymer, or other materials, depending on requirements.

The outer tubular layer 13 may be made of a material selected from the group consisting of nitrile-butadiene rubber, ethylene-propylene-diene terpolymer, nylon, polyimide, polyolefin-type materials such as PE, PP, PS, and PVC, and fluorinated polymer, such as PTFE, ETFE, PEFA, PEP, PVF, FEP, etc.

Typically, a cell size of the foam of the inner foam layer 12 may depend on its manufacturing process. It is possible to obtain minute cells by increasing a molding pressure rather than performing a curing reaction using a peroxide-type cross-linking agent at atmospheric pressure. For example, it is possible to obtain a cell size of 0.15 mm at 1 MPa or 0.05 mm at 9.5 MPa. A cell count of the foam is 50 per a unit inch, and a shape of the foam depends on the shape of a molding die.

The electrical resistance of the inner foam layer 12 is 104Ω to 108Ω, and more preferably, 105Ω to 106Ω. When the electrical resistance of the inner foam layer 12 is smaller than 105Ω, the productivity may decrease due to problems arising with the form in the inner foam layer 12 during the formation of the inner foam layer 12. When the electrical resistance of the inner foam layer 12 is larger than 108Ω, the image density may decrease.

To obtain a satisfactory electrical resistance of the inner foam layer 12, the inner foam layer 12 may include ionic conductive materials such as perchlorate, chlorate, ammonium salt, or a compound of these.

In addition, the electrical resistance of the outer tubular layer 13 is in a range of 103Ω to 105Ω, and more preferably, smaller than 103Ω. When the electrical resistance of the outer tubular layer 13 is larger than that of the inner foam layer 12, irregular electric fields caused by irregular resistance distribution at a contact surface between the inner foam layer 12 and the outer tubular layer 13 may generate irregular image density through the outer tubular layer 13. Even when the electrical resistance of the outer tubular layer 13 is greater than 105Ω, irregular image density may occur.

In order to give the tube sufficient conductivity, carbon black such as ketjen black, or acetylene black, metal oxides, such as zinc oxide, titanium oxide, magnesium oxide, etc., metal powder such as silver powder, etc., or fiber may be mixed with an electrical insulator. Otherwise, perchlorate, chlorate, ammonium salt, or the like may be added to the inner foam layer 12 and the outer tubular layer 13.

In the tubular roller according to the present embodiment, hardness of the outer tubular layer 13 is in a range of 15 to 45 degrees (Asker type-A). When the hardness is smaller than 15 degrees, it may be difficult to obtain a desired resistance and productivity. When the hardness is larger than 45 degrees, mechanical stress may cause toner defects.

A thickness of the outer tubular layer 13 in a finished tubular roller is in a rage of 75 to 100 μm when manufactured in a centrifugal forming process using a polyimide material, and 0.8 to 2 mm when manufactured in an extrusion method using NBR, EDPM, PC, nylon, PE, PP, PVC, PET, PBT, PEN, or equivalent materials.

The tubular roller according to the present embodiment may be subject to a surface roughness adjustment process as described below. An average surface roughness Ra of the outer tubular layer 13 after the adjustment process is in a range of 0.5 to 3.5 in a circumferential direction. When the surface roughness of the outer tubular layer 13 is smaller than 0.5, the toner may be inappropriately supplied. When the surface roughness of the outer tubular layer 13 is larger than 3.5, a thickness of a toner layer formed on the tubular roller may significantly increase and cause an irregular printing image.

According to an another aspect of the present general inventive concept, a method of manufacturing a tubular roller includes fabricating the outer tubular layer 13 by extrusion or centrifugal forming, mixing an elastomer, a crosslinking agent, a crosslinking accelerator, a blowing agent, and a conductive additive, inserting the mixture into the outer tubular layer 13, and heating the mixture to foam to provide an inner foam layer 12.

In an extrusion process, a non-sulfurated rubber, the crosslinking agent, the crosslinking accelerator, the blowing agent, and the conductive additive are injected into a hopper of an extruder, and the rubber is extruded at a temperature of 50-100° C. and a screw speed of 30-100 rpm. The extruded rubber is passed through a double-tubular mold to obtain a tubular extruded material. In this case, the extruded material is not sulfurated.

After the outer tubular layer 13 is formed, the elastomer, the crosslinking agent, the crosslinking accelerator, the blowing agent, and the conductive additive are mixed to provide the inner foam layer 12. Then, a roller-shaped non-sulfurated extruded material is obtained by a similar extrusion method to that used for the outer tubular layer 13. The roller-shaped extruded material is injected into the outer tubular layer, heated, sulfurated, and then foamed to provide a tubular roller.

The elastomer used in manufacturing the inner foam layer 12 includes those described above. The crosslinking agent may include, but is not limited to, sulfide or dicumyl peroxide of formula (1) below:

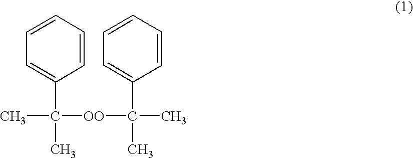

In addition, the crosslinking accelerator may include, but is not limited to, multifunctional vinyl monomer such as divinyl benzene, acrylate, or methacrylate polyol.

The blowing agent may include, but is not limited to, chloro-fluoro-carbon (CFC) or azodicarbonamide (ACA) of formula (2) below:
H₂NCON═NCONH₂ (2)

The conductive additive for giving conductivity to the tubular tube may include carbon black, metal oxide, metal powder, fiber, or various salts.

After mixing the elastomer, the crosslinking agent, the crosslinking accelerator, the blowing agent, and the conductive additive of the inner foam layer 12 is injected into the outer tubular layer 13, and then heated and foamed.

The temperature for the foaming process may be in a range of 150° C. to 200° C. When the heating temperature is lower than 150° C., the rubber may be not be sulfurated. When the heating temperature is higher than 200° C., mechanical strength may be decreased by overheating.

According to a conventional method of manufacturing a roller, a conductive polymer is extruded through a tube and foams to form the roller. In this case, a foam layer is inappropriately bound to the tube, and gaps exist therebetween, so that irregular electric fields are generated and the image quality deteriorates.

In a method of manufacturing a tubular roller according to an embodiment of the present general inventive concept, a mixture for forming a foam material is injected into the outer tubular layer 13 and then foamed. Therefore, it is possible to solve conventional problems relating to the binding between the foam layer and the tube and to avoid printing quality deterioration caused by the gaps therebetween.

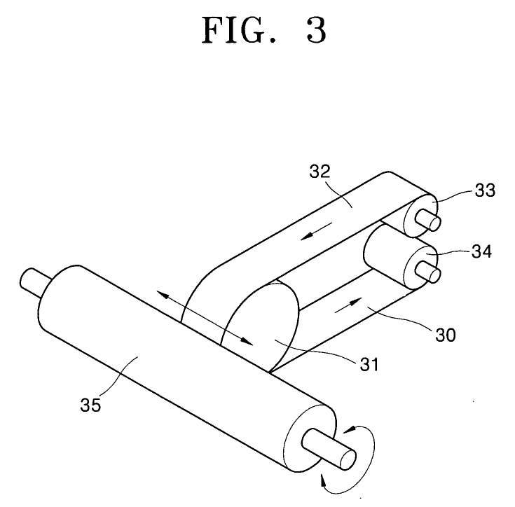

The method of manufacturing the tubular roller according to the present embodiment may further include adjusting the surface roughness of the outer tubular layer. The surface roughness adjustment may be performed using a roller processing machine 30 shown in FIG. 3.

The roller processing machine 30 may include a processing roller 31 which has a drum shape and moves left and right, sandpaper 32 passing around the processing roller 31, an upper sandpaper roller 33 around which one end of the sandpaper 32 is wound, and a lower sandpaper roller 34 around which the other end of the sandpaper 32 is wound.

In the roller processing machine 30, while the sandpaper 32 wound around the upper sandpaper roller 33 is advanced as the lower sandpaper roller 34 rotates, and the processing roller 31 moves left and right, an outer surface of the outer tubular layer 35 is sanded by abrasion with the sandpaper 32. In addition, abrasion between the sandpaper 32 and the outer tubular layer 35 leads to gentle protrusions on the outer surface of the outer tubular layer 35, and the gentle protrusions are further processed. Through these processes, the surface roughness of the outer tubular layer 35 can be controlled. After the completion of the surface roughness control processes, the outer tubular layer 35 has an average surface roughness (Ra) of 0.5-3.5 in a circumferential direction.

When an unsaturated hydrocarbon polymer having a double-bond structure is used, the surface roughness may be adjusted by irradiating ultraviolet rays, and a coefficient of friction may be controlled to 1.0 or less.

In a conventional method of manufacturing a developing roller, two or more additional abrasion cycles must be performed in order to adjust the surface roughness. Therefore, energy consumption and manufacturing cost are high. On the other hand, the present general inventive concept can solve these problems.

According to the present embodiment, a diameter obtained by extrusion and sulfuration is nearly the same as that of the finished product. Therefore, a separate abrasion process for adjusting the diameter is not necessary, and only a polishing process is necessary to adjust the surface roughness. Therefore, the manufacturing cost can be reduced.

According to an embodiment of the present general inventive concept, there is provided an electro-photographic image forming apparatus including a tubular roller.

The tubular roller according to the present general inventive concept can be used as a developing roller or an electrical charging roller in various electro-photographic image forming apparatuses such as a laser printer, a facsimile, or a duplicator. Specifically, it can be used as a developing roller or an electrical charging roller in a laser beam or an LED print head type printer, a facsimile, a duplicator and a multi-functional machine,

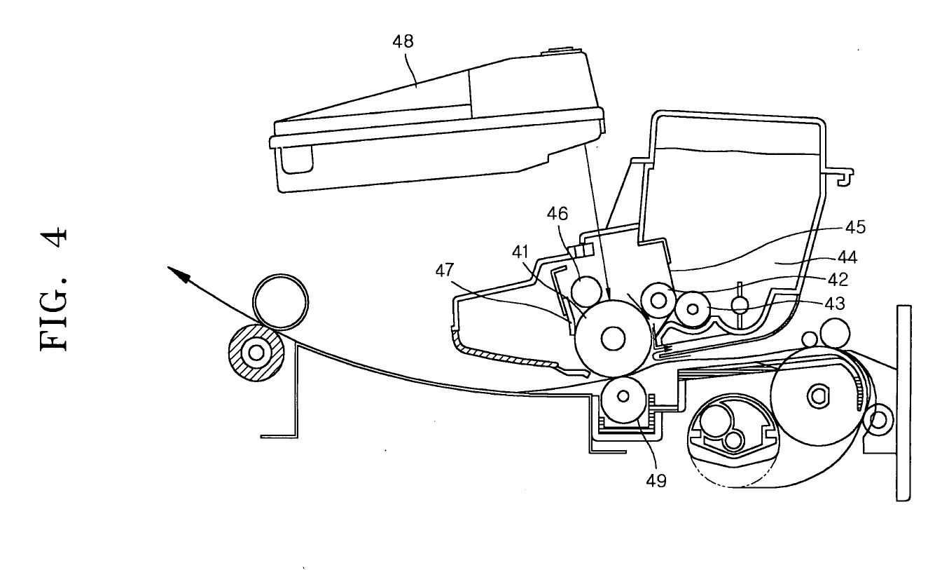

FIG. 4 is a cross-sectional view of a contact type one-component non-magnetic electro-photographic imaging apparatus having a tubular roller according to an embodiment of the present general inventive concept.

Referring to FIG. 4, a photosensitive unit 41 is electrically charged by an electrical charging roller 46, and a latent image is formed on the photosensitive unit 41 by image exposure with a laser scanning unit (LSU) 48. Toner 44 is supplied to a developing roller 42 by a toner supply roller 43. The toner 44 supplied to the developing roller 42 is reduced to a tin film by a toner layer controller 45 and charged by a friction at the same time. The toner 44 passing through the toner layer controller 45 is used to develop by an electrostatic latent image formed on the photosensitive unit 41. The developed toner is transferred to paper by a transfer roller 49 and fixed by a fixation roller (not shown). The toner 44 remaining in the photosensitive unit 41 after the transfer process is cleaned out by a cleaning blade 47.

The tubular roller according to the present embodiment can be used as an electrical charging roller or a developing roller in the aforementioned electro-photographic image forming apparatuses.

Hereinafter, the present embodiment will be described in more detail with reference to the following examples. The following examples are only for illustrative purposes and are not intended to limit the scope of the present general inventive concept.

As a tubular roller according to the present embodiment, an ionic conductive tubular roller and an electronic conductive tubular roller were manufactured as follows.

### EXAMPLE 1

### Manufacture of Ionic Conductive Tubular Roller

To manufacture an outer tubular layer, 10 parts by weight of NBR, 90 parts by weight of ECO, 8 parts by weight of an ammonium salt of a perfluorinated alkyl acid, 5 parts by weight of sulfur, and 1 part by weight of divinyl benzene were mixed at atmospheric pressure and room temperature. Then, the mixture was injected into a hopper of an extruder, and extruded at a temperature of 50-100° C. and an extrusion speed of 30-100 rpm. The extruded mixture (rubber) was passed through a mold having a double-pipe round shape to obtain a tubular shape. Here, the extruded material was not yet sulfurated. The mold was manufactured using a die having a diameter φ of 13-15, so that the final mold had a diameter φ of 13-15.

Since heat was generated during the mixing process, the mixing process was performed at a lower temperature than a half period temperature (e.g. 80-150° C.) of a foaming agent ACA.

To provide an inner foam layer, a foaming agent, e.g. ACA (3 parts by weight) was added to the mixture having the same composition as described above. The mixture was injected into the outer tubular layer, which was previously prepared, and heated in an oven to allow sulfuration and a foaming reaction. The temperature of the oven for the foaming reaction was 130-180° C.

The surface roughness of the outer tubular layer was adjusted to a range of 0.5 to 3.5 (in the circumferential direction) using the roller processing machine shown in FIG. 3.

### EXAMPLE 2

### Electronic Conductive Tubular Roller

An electronic conductive tubular roller was manufactured in the same manner as for the ionic conductive tubular roller in Example 1, except that carbon black was used as a conductive additive instead of 90 parts by weight of ECO and 8 parts by weight of an ammonium salt of a perfluorinated alkyl acid.

100 parts by weight of styrene-butadiene rubber, 20 parts by weight of carbon black, 5 parts by weigh of sulfur, 1 part by weight of divinyl benzene, and 3 parts by weight of ACA were mixed at an atmospheric pressure and room temperature.

The outer tubular layer and the inner foam layer were manufactured by the same method as described in Example 1. The electronic conductive extrusion material was injected into the outer tubular layer, and then heated in an oven to allow sulfuration and a foaming reaction. The temperature of the oven for the forming reaction was maintained within the range of 130-180° C.

The surface roughness of the manufactured outer tubular layer was adjusted to within the range of 0.5 to 3.5 (in the circumferential direction) by using the roller processing machine shown in FIG. 3.

The outer tubular layer manufactured using SBR has a higher wear-out resistance and a longer lifetime than that manufactured using NBR. Therefore, it is preferable to use only SBR or a blend of SBR and NBR.

### Measurement of Resistance and Hardness

The electrical resistance and hardness of the tubular rollers manufactured according to Examples 1 and 2 were measured.

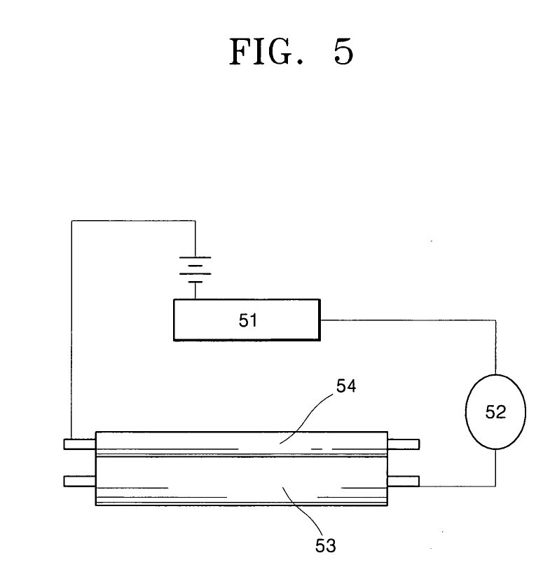

The electrical resistance was measured using an apparatus shown in FIG. 5, which includes a voltage supply device 51, a current meter 52, and a jig 53. In this apparatus, a tubular roller 54 to be measured was connected to the jig 53, and its electrical resistance was measured.

The result of the measurement shows that, for the ionic conductive tubular roller according to Example 1, the electrical resistance of the inner foam layer was 5×10⁶Ω, and the electrical resistance of the outer tubular layer was 10³Ω, so that the overall electrical resistance was 10⁶Ω. For the electronic conductive tubular roller according to Example 2, the electrical resistance of the inner foam layer was 10⁵Ω, and the electrical resistance of the outer tubular layer was 10³Ω, so that the overall electrical resistance was 10⁵Ω.

The tubular rollers according to Examples 1 and 2 respectively had surface hardnesses of 35 and 40 degrees (Asker A-type). Therefore, it is possible to produce a roller having a hardness of less than 40 degrees.

According to the present invention, it is possible to solve problems, such as migration of low molecular weight additives and streaks, due to viscosity in a stepped developing roller. Also, it is possible to implement a low hardness of less than 40 degrees. Also, it is possible to efficiently solve conventional problems related to the bonding between the foam layer and the tube and the bad printing image quality due to gaps therebetween. Also, a separate coating process for adjusting abrasion or surface roughness is not necessary, and the manufacturing process is simple and inexpensive. Also, it is possible to apply the tubular roller to various kinds of electro-photographic image forming apparatuses such as a contact non-magnetic one-component type and a magnetic two-component type. Furthermore, it is possible to use the tubular roller according to the present embodiment as an electrical charging roller as well as a developing roller.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An elastic tubular roller to provide electrical conductivity to an image forming apparatus, comprising:
an inner foam layer and an outer tubular layer,
wherein the inner foam layer has a higher electrical resistance than the outer tubular layer, and an electrical resistance of the entire tubular roller is equal to or less than 108Ω.

2. The tubular roller according to claim 1, wherein the inner foam layer is formed of a material selected from the group consisting of polyurethane, silicon rubber, ethylene-propylene-diene terpolymer, nitrile-butadiene rubber, polyolefin, nylon, polyimide, a copolymer thereof, and a mixture thereof, and the outer tubular layer is formed of a material selected from the group consisting of nitrile-butadiene rubber, ethylene-propylene-diene terpolymer, nylon, polyimide, polyolefin, fluorinated polymer, and a mixture thereof.

3. The tubular roller according to claim 1, wherein the outer tubular layer contains carbon black, styeren-butadiene rubber, or a blend of SBR and NBR, and has an electrical resistance of less than 105Ω.

4. The tubular roller according to claim 1, wherein the electrical resistance of the inner foam layer is in a range of 104Ω to 108Ω, and the inner foam layer contains an ionic conductive material selected from the group consisting of perchlorate, chlorate, ammonium salt, and a mixture thereof.

5. The tubular roller according to claim 1, wherein the electrical resistance of the inner foam layer is in a range of 105Ω to 106Ω, and the inner foam layer contains an ionic conductive material selected from the group consisting of perchlorate, chlorate, ammonium salt, and a mixture thereof.

6. The tubular roller according to claim 1, wherein the electrical resistance of the outer tubular layer is in a range of 103Ω to 105Ω.

7. The tubular roller according to claim 1, wherein the electrical resistance of the outer tubular layer is less than 103Ω.

8. The tubular roller according to claim 1, wherein the tubular roller further contains carbon black, metal oxide, metal power, fiber, perchlorate, chlorate, or ammonium salt.

9. The tubular roller according to claim 1, wherein the tubular roller has a hardness of 15 through 45 degrees (Asker type-A).

10. The tubular roller according to claim 1, wherein an average surface roughness Ra of the outer tubular layer is in a range of 0.5 to 3.5 in a circumferential direction thereof.

11. The tubular roller according to claim 1, wherein the outer tubular layer has a thickness of 2 mm or less.

12. The tubular roller according to claim 1, wherein the outer tubular layer has an average surface roughness Ra of 1.0 through 3.0, and a thickness of 1.0 mm or less.

13. The tubular roller according to claim 1, wherein the inner foam layer comprises cells having a cell size of one of 0.15 mm and 0.05 mm.

14. The tubular roller according to claim 1, wherein the inner foam layer is made of an elastomer mixed with a non-sulfurated rubber, a crosslinking agent, a crosslinking accelerator, a blowing agent, and a conductive additive.

15. The tubular roller according to claim 14, wherein the crosslinking agent comprises sulfide or dicumyl peroxide having the following formula:

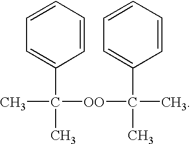

16. The tubular roller according to claim 14, wherein the crosslinking accelerator comprises multifunctional vinyl monomer.

17. The tubular roller according to claim 14, wherein the blowing agent comprises chloro-fluoro-carbon (CFC) or azodicarbonamide (ACA) of the following formula:
H₂NCON═NCONH₂.

18. A method of manufacturing a tubular roller usable in an image forming apparatus, the method comprising:
providing an outer tubular layer by an extrusion or centrifugal forming process;
mixing an elastomer, a crosslinking agent, a crosslinking accelerator, a blowing agent, and a conductive additive to obtain a mixture;
obtaining an extruded material having a roller shape using the mixture through a second extrusion process similar to the extrusion process of the outer tubular layer, and injecting the extruded material into the outer tubular layer; and
heating the injected material to foam to provide an inner foam layer.

19. The method according to claim 18, wherein a diameter of the outer tubular layer is larger than that of the extruded material during the injection of the extruded material into the outer tubular layer.

20. An electro-photographic image forming apparatus, comprising:
a tubular roller having an inner foam layer and an outer tubular layer,
wherein the inner foam layer has a higher electrical resistance than the outer tubular layer, and an electrical resistance of the entire tubular roller is equal to or less than 108Ω.

21. The apparatus according to claim 20, further comprising:
a developing roller,
wherein the tubular roller is used as a developing roller.

22. The apparatus according to claim 20, further comprising:
an electrical charging roller,
wherein the tubular roller is used as an electrical charging roller.

23. The apparatus according to claim 20, wherein the inner foam layer is formed of a material selected from the group consisting of polyurethane, silicon rubber, ethylene-propylene-diene terpolymer, nitrile-butadiene rubber, polyolefin, nylon, polyimide, a copolymer thereof, and a mixture thereof, and the outer tubular layer is formed of a material selected from the group consisting of nitrile-butadiene rubber, ethylene-propylene-diene terpolymer, nylon, polyimide, polyolefin, fluorinated polymer, and a mixture thereof.

24. The apparatus according to claim 20, wherein the outer tubular layer contains carbon black, styeren-butadiene rubber, or a blend of SBR and NBR, and has an electrical resistance of less than 105Ω.

25. The apparatus according to claim 20, wherein the electrical resistance of the inner foam layer is in a range of 104Ω to 108Ω, and the inner foam layer contains an ionic conductive material selected from the group consisting of perchlorate, chlorate, ammonium salt, and a mixture thereof.

26. The apparatus according to claim 20, wherein the electrical resistance of the inner foam layer is in a range of 105Ω to 106Ω, and the inner foam layer contains an ionic conductive material selected from the group consisting of perchlorate, chlorate, ammonium salt, and a mixture thereof.

27. The apparatus according to claim 20, wherein the electrical resistance of the outer tubular layer is within the range of 103Ω to 105Ω.

28. The apparatus according to claim 20, wherein the electrical resistance of the outer tubular layer is less than 103Ω.

29. The apparatus according to claim 20, wherein the tubular roller further contains carbon black, metal oxide, metal power, fiber, perchlorate, chlorate, or ammonium salt.

30. The apparatus according to claim 20, wherein the tubular roller has a hardness of 15 through 45 degrees (Asker type-A).

31. The apparatus according to claim 20, wherein an average surface roughness Ra of the outer tubular layer is in a range of 0.5 to 3.5 in a circumferential direction thereof.

32. The apparatus according to claim 20, wherein the outer tubular layer has a thickness of 2 mm or less.

33. The apparatus according to claim 20, wherein the outer tubular layer has an average surface roughness Ra of 1.0 through 3.0, and a thickness of 1.0 mm or less.
